(19) United States
(12) Patent Application Publication
(10) Pub. No.: US 2010/0192652 A1
(43) Pub. Date: Aug. 5, 2010

(54) TEMPORARY SPACER DEVICE EQUIPPED WITH LOCKING MEANS

(75) Inventor: Stephane Perche, Saint Bardoux (FR)

Correspondence Address: CANTOR COLBURN, LLP, 20 Church Street, 22nd Floor, Hartford, CT, 06103, US

(73) Assignee: EXSTO, Romans sur Isere (FR)

(21) Appl. No.: 12/677,140

(22) PCT Filed: Sep. 10, 2008
(86) PCT No.: PCT/EP2008/061986

§ 371 Date: Mar. 25, 2010

(30) Foreign Application Priority Data
Sep. 12, 2007 (FR) 0706392

(51) Int. Cl. E05B 17/00

(52) U.S. Cl. 70/431

(57) ABSTRACT

The present invention relates to a device (1) for temporarily spacing an opening element away from a fixed element of a motor vehicle bodywork (15), comprising a mount (2) that bears means (3, 4) of attachment allowing the device to be anchored in the fixed element, and blocking means (6) designed to be able to deform elastically, characterized in that it comprises locking means (8, 10, 12, 13) capable of moving from an initial unlocked position in which the blocking means put up minimal resistance towards the opening element, to a locked final position in which the blocking means prevent the said opening element from moving back.

### TECHNICAL FIELD

The invention relates to a device for temporarily spacing an opening element away from a fixed body element of a motor vehicle.

### BACKGROUND

Before the final fastening of an opening element, such as a door, a hood or a tailgate, inter alia, to a fixed element of a motor vehicle body, steps of applying one or more coatings, such as protective coatings or a layer of paint, are generally carried out. During such treatments, these opening elements are not yet equipped with final closure devices, for example locks.

For this reason, temporary spacer devices are provided for keeping an opening element in a pseudo-closed position with respect to the fixed element to which it is intended to be fastened.

Documents FR 2 885 633, FR 2 885 634 and FR 2 885 635 each describe a device of this type comprising a mounting plate intended to anchor the device in the fixed element and also a component fastened to the mounting plate and forming an abutment against which the opening element can bear and which can deform under the action of stresses exerted by the opening element.

Thus, the provision of a part of the abutment that is able to deform elastically enables impacts with the opening element to be absorbed. In this way, the resistance to forces is greatly improved and any deformation of the opening element or breakage of the temporary spacer device as a result of an impact is prevented.

However, one of the drawbacks of each of these devices lies in the fact that, when the opening element comes into contact with the abutment and forces the latter to move aside, the friction produced can flake off the layer or layers of paint applied to the opening element and/or generate the undesired formation of chips of plastic originating both from plastic parts of the body and from the temporary locking device itself. In addition, these flakes and/or chips can then be deposited on regions of the body under the effect of gravity and/or spraying and cause defects during the application of further layers. This results in a visual imperfection both on the opening element and on the fixed element, which manufacturers wish to be able to eliminate.

### BRIEF SUMMARY

The invention aims to solve, entirely or partially, the abovementioned problem, and for this purpose provides a device for temporarily spacing an opening element away from a fixed body element of a motor vehicle, comprising a base comprising mounting means for anchoring the device in the fixed element or the opening element and also blocking means designed so as to be able to deform elastically under the action of stresses exerted by the opening element or the fixed element, characterized in that said device comprises locking means able to pass from an initial unlocked position, in which the blocking means offer minimal resistance to the opening element, into a final locked position, in which the blocking means stop said opening element from moving backward.

Thus, the blocking means offer no resistance to the opening element when the latter is moved into its pseudo-closed position, the result of this being that any risk of the coating being damaged by friction is prevented. The locking means ultimately have the effect of reinforcing the rigidity of the blocking means such that the opening element cannot move backward beyond a predetermined clearance unless it is pulled hard enough to force the locking means to come out of the blocking means or unless the locking means are detached manually from said blocking means.

According to a first preferred embodiment of the invention, the locking means are designed to move into the locked position under the direct action of the opening element or the fixed element. In this way, they pass into the locked position automatically, driven by the blocking means when the latter are made to deform and move aside under the effect of the stresses exerted by the opening element or by the fixed element.

Such a device can thus be easily installed and enables automatic locking which does not require the implementation of any particular manual steps.

According to a second preferred embodiment of the invention, it should be understood that it is possible for the passage from the initial unlocked position into the final locked position to be carried out manually once the opening element is in the pseudo-closed position. All that is necessary for this purpose is to keep the opening element in its pseudo-closed position, for example manually, while locking the locking means manually.

Preferably, the blocking means comprise at least one member forming an abutment.

Further preferably, the member forming an abutment is in the form of a tongue. In addition, the tongue is preferably mounted such that it can pivot on the base.

The device thus preferably comprises means designed to limit the pivoting of the tongue in the locking direction.

Advantageously, the locking means comprise at least one retaining member able to be locked in the base.

Further advantageously, the retaining member is secured to the blocking means.

Preferably, at least one retaining element secured to the base is designed to engage with the retaining member.

Further preferably, the retaining member and the retaining element are designed such that they can engage with one another by mating of shapes.

According to a preferred variant embodiment of the invention, at least one retaining member protruding from the tongue is in the form of a tab provided with a protrusion at its free end, said protrusion being oriented toward the base and being designed to be locked in at least one complementary retaining element secured to the base under the action of the opening element.

The retaining element is preferably in the form of a pillar secured to the base, said pillar having a free end in which there is formed a slot designed to enable the protrusion to be locked by snap engagement.

Preferably, the device comprises two tabs and two pillars and the two tabs are located on either side of the tongue.

Further preferably, the width of the tongue is less than the distance between the two pillars. The tongue can thus pivot between the two pillars under the action of the stresses exerted by the opening element, such that the protrusions of the tabs are made to pass beyond the corresponding free ends of the pillars.

When these stresses stop, that is to say once the opening element has passed beyond the tongue, the latter tends to return to its initial position by elasticity, which results in a movement backward. The latter is, however, stopped due to the snap engagement of the protrusions in the slots in the pillars. The locking means are then activated and any movement backward of the opening element beyond a predetermined clearance is impossible unless it is pulled hard enough to force the protrusions to come out of the slots.

Unlocking can also alternatively be carried out by manual intervention. Specifically, it suffices to pivot the tongue slightly toward the fixed element in order to remove the protrusions from the slots, and then to move said tabs apart radially in order to deactivate the locking means.

A significant advantage of a device according to the invention lies then in the fact that it can be reversible and can be used again, if appropriate following a cleaning step.

### BRIEF DESCRIPTION OF THE DRAWINGS

The implementation of the invention will be understood better with the aid of the detailed description given below with regard to the appended drawing, in which:

FIG. 1 is a perspective view of a temporary spacer device according to the first preferred embodiment of the invention;

FIG. 2 is a partial perspective view of the body of a motor vehicle equipped with the device shown in FIG. 1;

FIG. 3 is a side view of the device shown in FIG. 1 in an initial unlocked position;

FIG. 4 is a view similar to FIG. 3 once the device is in the final locked position; and

FIG. 5 is a view similar to FIG. 3 of another exemplary embodiment of the temporary spacer device according to the invention.

### DETAILED DESCRIPTION

In the following detailed description of the figures defined hereinabove, the same elements or elements fulfilling identical functions have the same references in order to simplify the understanding of the invention.

A temporary spacer device 1, as shown more particularly in FIGS. 1, 3 and 4, is produced by molding in the form of a one-piece body made of plastic, for example based on polyamide, such that it can withstand the high temperatures to which said device is subjected during painting steps while offering properties of elasticity and relatively low manufacturing costs.

Traditionally, and as is shown and described in documents FR 2 885 633, FR 2 885 634 and FR 2 885 635, this device 1 comprises an elongate base 2 having a mounting plate 3 from the bottom part of which a mounting peg 4 protrudes.

The base 2 has an upper face 5 from which protrude, firstly, a tongue 6 terminating in an upper enlarged free end 7 forming an abutment and, secondly, two rigid pillars 8.

More precisely, the two pillars 8 are formed on either side of the end 16 of the base 2, this end 16 facing the fixed element (not shown). These two pillars 8 each have an upper free end provided with a protuberance 9 delimiting a slot 10 forming a housing and oriented toward the fixed element.

A recess 11 is formed in the bottom part of the tongue 6 in the region where the latter is fastened to the base 2, so that the tongue 6 is mounted such that it can pivot on the upper face 5 transversely to the longitudinal axis of the base 2. In addition, this recess 11 limits the forces that have to be applied to force said tongue 6 to pivot about its axis.

The width of the tongue 6 is selected to be less than the distance between the two pillars 8, such that said tongue 6 can pass between the two pillars 8 as it is pivoted counterclockwise with reference to FIG. 1.

The tongue 6 also has two tabs 12 secured to the free end 7, surrounding said tongue 6 and each provided with a beveled protrusion 13 oriented downward. These two tabs 12 are slightly inclined downward so as to converge toward the pillars 8 of the base 2 and are formed to have a certain radial elasticity.

Moreover, on its opposite face, the tongue 6 has a protruding nose 14 over part of its length.

As is shown more particularly in FIG. 3, the tongue 6 is inclined slightly backward with respect to the end 16 when the device 1 is at rest. The protrusion 13 of each of the two tabs 12 is then vertically above the pillar 8 corresponding to it.

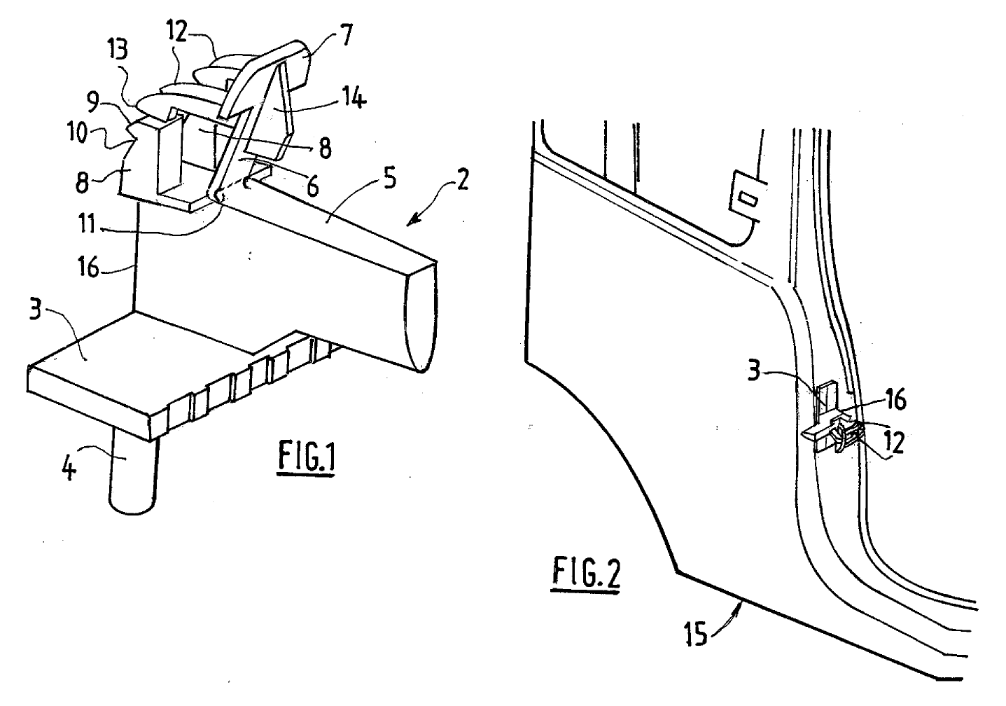

FIG. 2 shows an example of the application of a device 1 according to the invention to the body 15 of a motor vehicle. In this example, the device 1 is arranged so as to be able to keep an opening element, in this case a door (not shown), in a pseudo-closed position during steps of painting and/or applying coating layers.

When the door is then closed, the latter conventionally strikes the nose 14 of the tongue 6. The latter is then rotated clockwise as is shown by the arrow in FIG. 3, and moves aside under the action of the door, only offering negligible minimal resistance. As a result, friction produced at the nose 14 and the free end 7 is not liable to damage the coating layer or layers already applied to the door and/or the nose 14 and the free end 7 themselves.

Under the action of the door, the tongue 6 pivots between the two pillars 8 such that, given the inclination of the tabs 12, each protrusion 13 is first of all forced to slide over the upper end of the corresponding pillar 8 and then to pass beyond the upper ends of the pillars 8.

As is shown in FIG. 4, these protrusions 13 finally engage like a harpoon with the corresponding slots 10 of the pillars 8 when the door reaches its pseudo-closed position and the tongue 6, free of any stress, tends to return to its initial position by elasticity.

Thus, the tongue 6 is automatically locked by snap engagement by way of the tabs 12 and the pillars 8, and the door is then locked in the pseudo-closed position, the locking function having been carried out with no manual intervention.

If the door tends to move backward, it butts against the free end 7 and from then on is incapable of pivoting counterclockwise. Specifically, the locking means are then activated and any movement backward of the door beyond a predetermined clearance is impossible unless the door is pulled hard enough to force the protrusions 13 to come out of the slots 10. This pulling operation is performed when the painting steps have been finished so as to enable final removal of the device 1 from the body 15.

This unlocking can also alternatively be carried out following a manual maneuver. For this purpose, it is sufficient firstly to pivot the tongue 6 clockwise with reference to FIG. 4 in order to remove the protrusions 13 from the slots 10 and then secondly to move the tabs 12 radially apart toward the outside in order that the protrusions can be located above the upper ends of the pillars 8 again. The tongue 6 finally returns automatically to its initial position by elasticity and the device 1 can be used again, if appropriate following a cleaning step.

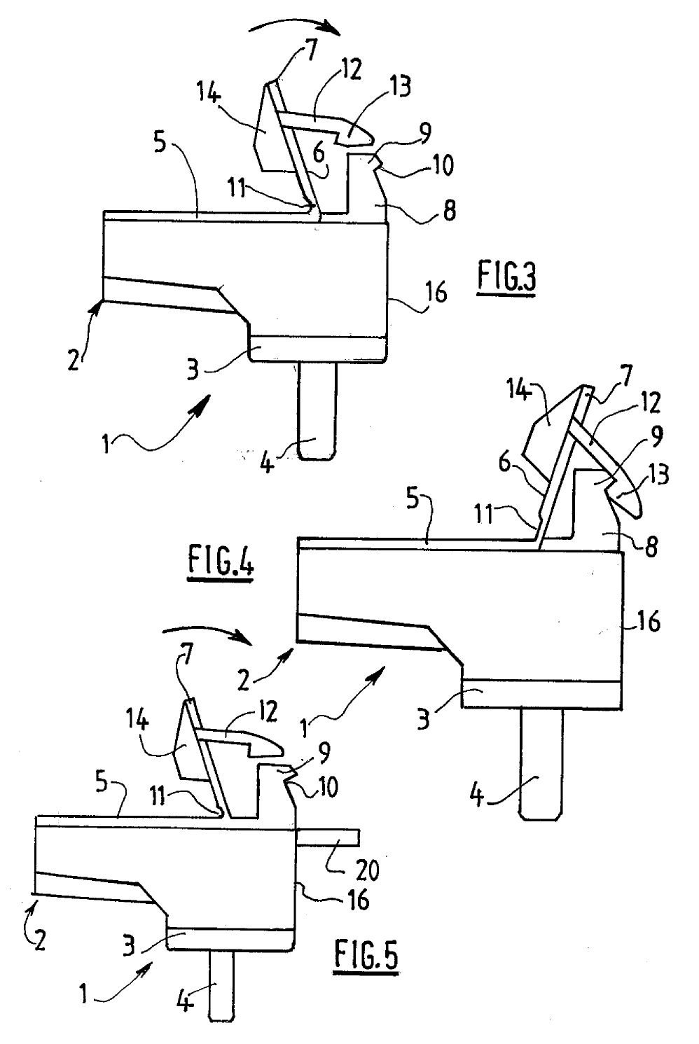

As is shown in FIG. 5, and in order for the device 1 to operate optimally during the automatic locking step, the device 1 may advantageously have a protuberance 20 protruding at right angles from the end 16. This protuberance 20 thus serves as an abutment for the protrusions 13 in order to limit the pivoting angle of the tongue 6.

Although the invention has been described in connection with particular exemplary embodiments, it is clear that it is in no way limited thereto and that it includes any technical equivalents of the means described as well as combinations thereof, as long as these are within the scope of the invention.

1. A device for temporarily spacing an opening element away from a fixed body element of a motor vehicle, comprising:
a base comprising mounting means for anchoring the device in the fixed element or the opening element and also; and
blocking means designed so as to be able to deform elastically under the action of stresses exerted by the opening element or the fixed element; and
locking means able to pass from an initial unlocked position, in which the blocking means offer minimal resistance to the opening element, into a final locked position, in which the blocking means stop said opening element from moving backward.

2. The device as claimed in claim 1, wherein the locking means are designed to move into the locked position under direct action of the opening element or the fixed element.

3. The device as claimed in claim 1, wherein the blocking means comprise at least one member forming an abutment.

4. The device as claimed in claim 3, wherein the member forming an abutment is in the form of a tongue.

5. The device as claimed in claim 4, wherein the tongue is mounted such that the tongue can pivot on the base.

6. The device as claimed claim 3, wherein the locking means comprise at least one retaining member able to be locked in the base.

7. The device as claimed in claim 6, wherein the retaining member is secured to the blocking means.

8. The device as claimed in claim 6, further comprising at least one retaining element secured to the base and designed to engage with the retaining member.

9. The device as claimed in claim 8, wherein the retaining member and the retaining element are designed such that they can engage with one another by mating of shapes.

10. The device as claimed in claim 5, wherein at least one retaining member protruding from the tongue is in a form of a tab provided with a protrusion at its a free end, said protrusion being oriented toward the base and being designed to be locked in at least one complementary retaining element secured to the base under action of the opening element.

11. The device as claimed in claim 10, wherein the retaining element is in a form of a pillar secured to the base, said pillar having a free end in which there is formed a slot designed to enable the protrusion to be locked by snap engagement.

12. The device as claimed in claim 11, further comprising two tabs and two pillars wherein the two tabs are located on either side of the tongue.

13. The device as claimed in claim 12, wherein the width of the tongue is less than the distance between the two pillars.

14. The device as claimed in claim 4, further comprising means designed to limit pivoting of the tongue in the locking direction.
